(19) United States
(12) Patent Application Publication
(10) Pub. No.: US 2020/0107990 A1
(43) Pub. Date: Apr. 9, 2020

(54) Acupressure gloves and/or finger cots with pellets

(71) Applicant: Chao Hsing Yeh, Baltimore, MD (US)

(72) Inventor: Chao Hsing Yeh, Baltimore, MD (US)

(21) Appl. No.: 16/048,431

(22) Filed: Jul. 30, 2018

(51) Int. Cl. A61H 39/04; A41D 19/00

(52) U.S. Cl. CPC A61H 39/04; A41D 19/0024; A41D 2400/324; A61H 2201/1635; A41D 2400/322; A61H 2201/165

(57) ABSTRACT

The invention, acupressure gloves/cots with attached single/multiple pellets are made of various materials. The materials such as cloth, rubber, leather, latex, neoprene, and knitted wool are used for making the gloves/cots. The pellets are made from stainless steel, 24k gold plated stainless steel, silver, titanium, magnetics, or Vaccaria seeds. The single or multiple pellets will be attached in the distal area on the palm surface of the gloves/cots. These five finger gloves or individual cots (thumb and index finger) can be worn by an individual like any other typical gloves, for the application of pressure on acupressure points for treatment. It provides people an alternative method of receiving acupressure treatment using gloves/cots that can be used anytime and/or anywhere to apply pressure on specific body/ear acupressure points to relieve any corresponding pathological ailments.

### CROSS REFERENCE TO RELATED APPLICATIONS

N/A

### BACKGROUND OF THE INVENTION

Acupressure is an effective method of stimulating certain pressure points on the body/ear to relieve any underlying pathological conditions/symptoms corresponding to those points. Typically, acupressure is administered by applying pressure using the pellets (metal beads, Vaccaria plant seed, etc.), which are secured with a piece of waterproof, adhesive, surgical tape on specific acupressure points of the body/ear. Several steps are taken to ensure that the pellet placed on the point does not fall off. First, the specific acupoint of interest is identified and cleaned with a damp cloth or alcohol wipe, followed by an antiseptic wipe to ensure a clean and dry surface for the application of the pellet. Thereafter, the pellets are taped to the points using adhesive tape.

The common drawback of using these pellets with adhesive surgical tapes are: (a) most of these adhesive tapes may loosen up over time and the pellets fall off; (b) since pellets with tape come in a disposable form, some people find it uncomfortable to wear it all the time; (c) some people are allergic to the tape.

### BRIEF SUMMARY OF THE INVENTION

The invention is an acupressure glove/finger cot that can be worn by the user on his/her hand or on index finger and thumb, like any other typical glove. The gloves/cots are made from various materials, such as cloth, rubber, leather, latex, neoprene, and knitted wool. The pellets attached to the gloves/cots include a variety of materials, such as stainless steel, 24k gold plated stainless steel, silver, titanium, magnets, or Vaccaria seeds. The size of each pellet is about ≈2 mm in diameter. Currently, tape with pellets is a common method to stimulate body/ear points for acupressure. However, there are drawbacks for the tapes/pellets: (1) allergies to the tape, (2) falling of pellets, (3) aesthetically unappealing, (4) health information disclosure issues (any person who has the knowledge of acupressure may understand the underlying pathology of a person receiving acupressure with pellets attached to their ear), and (5) discomfort while sleeping.

The invention of the acupressure finger gloves/cots can solve the issues above. The principal objective of this invention is to provide a glove/cots (for use in the thumb and index finger) that can be used anytime and/or anywhere to apply pressure on specific body/ear acupressure points to relieve any corresponding pathological ailments. Therefore, a person willing to receive acupressure does not have to wear the pellet all time.

### BRIEF DESCRIPTION OF REPLACEMENT DRAWINGS

Various renderings of the invention are disclosed in the following detailed description and accompanying drawings.

FIG. 1 illustrates an acupressure finger cot with a single pellet attached to it. The numbers represent acupressure points in the body.

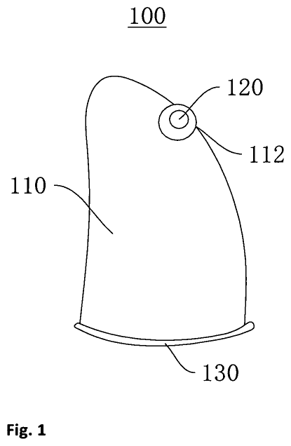

FIG. 2 illustrates an acupressure finger cot with multiple pellets attached to it. The numbers represent acupressure points in the body.

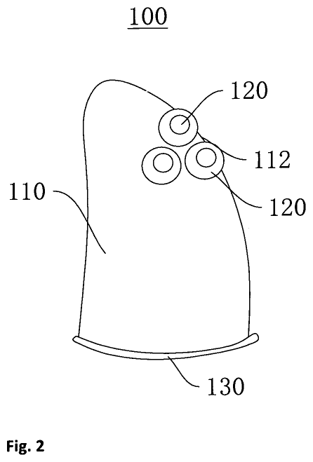

FIG. 3 illustrates an acupressure finger cot with a single pellet attached to it. The numbers represent acupressure points in the body.

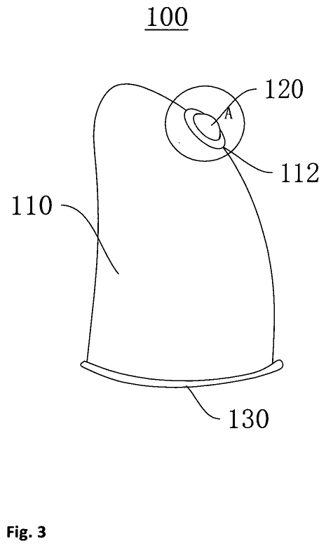

FIG. 4 illustrates a single pellet. The numbers represent acupressure points in the body.

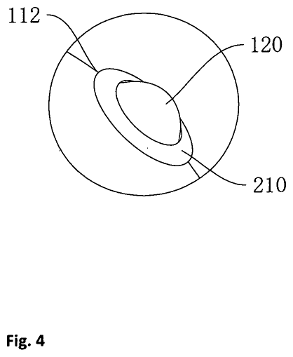

FIG. 5 illustrates an acupressure hand glove. The numbers represent acupressure points in the body.

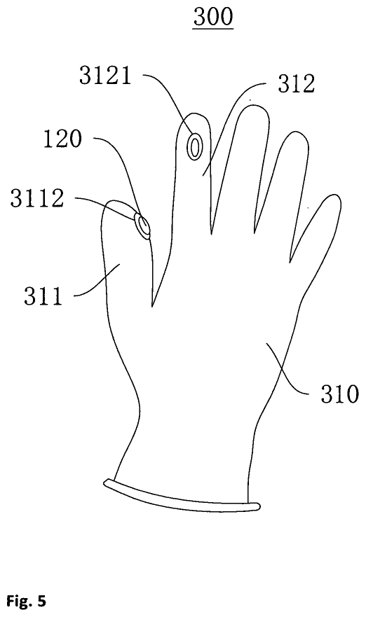

1. The invention claims that acupressure gloves with pellets; (a) will be sealed along the peripheries of the fingers until the wrist, (b) leaving an opening region, near the wrist to accommodate users to insert and withdraw their hand. Other characteristics of the gloves are: (a) The gloves will have components/parts which are slightly larger in dimension, corresponding to the respective fingers for easy wearing of gloves, (b) There will be single or multiple pellets attached to the distal surface of the palm. The size of each pellet will be ≈2 mm in diameter
The invention, acupressure cots (for thumb and index finger), will be (a), sealed along the sides of a finger leaving an opening near the proximal interphalangeal joint, and (b), slightly larger in dimension to accommodate users to easily insert and withdraw their finger. There will be single or multiple pellets attached to the distal surface of the palm. The size of each pellet will be ≈2 mm in diameter.
